(19) United States
(12) Patent Application Publication
(10) Pub. No.: US 2013/0332413 A1
(43) Pub. Date: Dec. 12, 2013

(54) REDUCING DATA TRANSFERS WHILE ELIMINATING DATA LOSS FOR ASYNCHRONOUS REPLICATION OF DATABASES

(71) Applicants: Harry M. Yudenfriend, Poughkeepsie, NY (US); Peter G. Sutton, Poughkeepsie, NY (US)

(72) Inventors: Harry M. Yudenfriend, Poughkeepsie, NY (US); Peter G. Sutton, Poughkeepsie, NY (US)

(73) Assignee: INTERNATIONAL BUSINESS MACHINES CORPORATION, Armonk, NY (US)

(21) Appl. No.: 13/490,606

(22) Filed: Jun. 7, 2012

(51) Int. Cl. G06F 17/30

(52) U.S. Cl. 707/611; 707/E17.005

(57) ABSTRACT

A method for reducing data transfers while eliminating data loss during database replication includes receiving one or more database log write operations caused by an application making updates to a database. The method also includes writing the one or more database log write operations on a database log stored at a primary site and asynchronously mirroring the database log to a secondary storage device located at a secondary site. The method also includes synchronously storing the one or more database log write operations on a secure storage unit at the primary site and receiving an indication of a disaster event at the primary site. In response to the indication of the disaster event, transmitting only the one or more database log write operations stored to the secure storage unit during a time interval to the secondary storage device.

### BACKGROUND

The present invention relates to database replication, and more specifically, to methods and systems for reducing data transfers while eliminating data loss that may occur due to a disaster while using asynchronous disk storage replication technologies.

Techniques for replicating databases at large distances are generally well known in the art. In general, asynchronous techniques are used for long distance replication because of the elongated input/output (I/O) service time that synchronous technologies require. Current methods of asynchronous replication of databases at long distances generally require a large amount of data that to be transmitted to a remote site which uses substantial bandwidth.

Examples of current asynchronous replication at long distances include sending all updates, or writes, to a database data file and a database transaction log to a remote site to populate a database at the remote site. Typically this is done by intercepting and transmitting all database write commands as they occur in addition to sending the database transaction log writes to the remote site. Many current systems use a local data recorder box (e.g., disaster proof Axxana Phoenix Data Recorder™) to synchronously capture updates to both the database data file and the database transaction logs. When using a local data recorder box, all of the recorded data is needed at the remote site in order to update a copy of the database that was created asynchronously and bring it up to the equivalent of a copy that was created synchronously.

While each of these techniques allow for a fully up-to-date consistent database image to be constructed at the remote site, they each require the transmission of a large amount of data from the primary site to the recovery site which results in the need for substantial bandwidth.

### SUMMARY

According to an exemplary embodiment, a method for reducing data transfers while eliminating data loss during database replication includes receiving one or more database log write caused by an application making updates to a database. The method also includes writing the one or more database log write operations on a database log stored at a primary site and asynchronously mirroring the database log to a secondary storage device located at a secondary site. The method also includes synchronously storing the one or more database log write operations on a secure storage unit at the primary site and receiving an indication of a disaster event at the primary site. In response to the indication of the disaster event, transmitting only the one or more database log write operations stored to the secure storage unit during a time interval to the secondary storage device.

According to another exemplary embodiment, a computer program product for reducing data transfers while eliminating data loss during database replication, the computer program product includes a tangible storage medium readable by a processing circuit and storing instructions for execution by the processing circuit for performing a method. The method includes receiving one or more database log write operations from an application and writing the one or more database log write operations on a database log stored at a primary site. The method also includes mirroring the database log to a secondary storage device located at a secondary site and storing the one or more database log write operations on a secure storage unit at the primary site. The method further includes receiving an indication of a disaster event at the primary site and in response to the indication of the disaster event, transmitting only the one or more database log write operations stored to the secure storage unit during a time interval to the secondary storage device.

According to yet another exemplary embodiment, a system for reducing data transfers while eliminating data loss during asynchronous database replication includes a primary storage device for storing a database log, a secondary storage device in communication with the primary storage device for storing an asynchronous mirrored copy of the database and the database log and a secure storage device in communication with the primary storage device. The system is configured to perform a method including receiving one or more database log write operations from the database as a result of an application making updates and writing the one or more database log write operations on the database log and synchronously storing the one or more database log write operations on the secure storage unit. The method also includes asynchronously mirroring the database log to the secondary storage device. The method further includes receiving an indication of a disaster event at the primary storage device site and in response to the indication of the disaster event, transmitting only the one or more database log write operations stored to the secure storage unit during a time interval to the secondary storage device.

Additional features and advantages are realized through the techniques of the present invention. Other embodiments and aspects of the invention are described in detail herein and are considered a part of the claimed invention. For a better understanding of the invention with the advantages and the features, refer to the description and to the drawings.

### BRIEF DESCRIPTION OF THE SEVERAL VIEWS OF THE DRAWINGS

The subject matter which is regarded as the invention is particularly pointed out and distinctly claimed in the claims at the conclusion of the specification. The forgoing and other features, and advantages of the invention are apparent from the following detailed description taken in conjunction with the accompanying drawings in which:

FIG. 1 is a block diagram that illustrates a system for asynchronous replication of a database in accordance with an exemplary embodiment;

FIG. 2 is a block diagram that illustrates a secure storage unit in accordance with an exemplary embodiment; and

FIG. 3 illustrates a flow diagram of a method for reducing data transfers while eliminating data loss during database replication in accordance with an exemplary embodiment.

### DETAILED DESCRIPTION

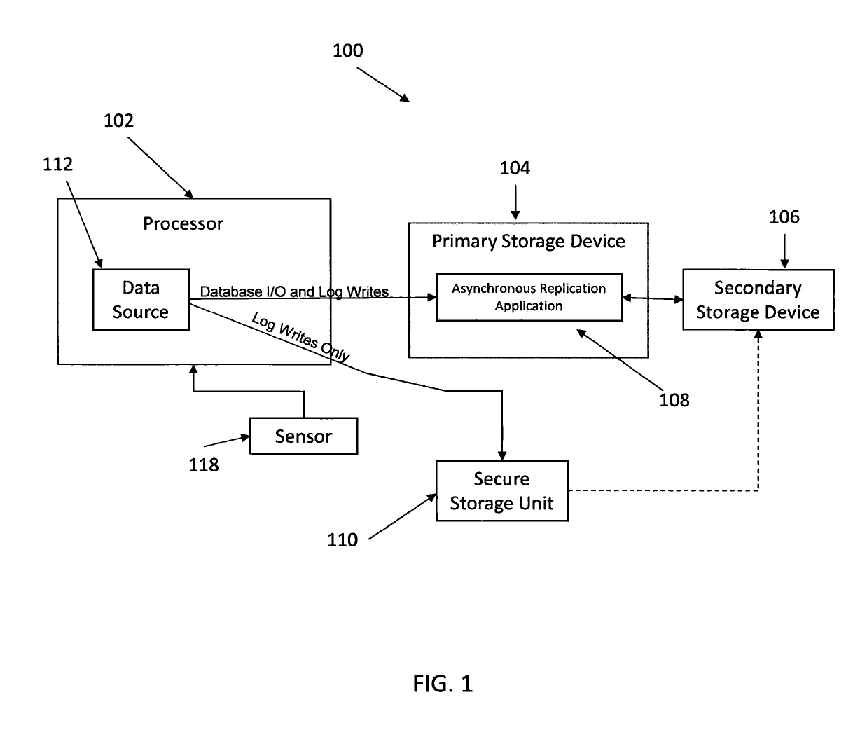

Referring now to FIG. 1, a block diagram illustrating a system 100 for asynchronous replication of a database in accordance with an embodiment is shown. The system 100 for asynchronous replication of a database may be used to ensure that a fully up-to-date consistent database is available at a secondary site after a disaster event occurs at a primary site. Disaster events may include any event that affects the database storage. A disaster event may include, for example, an earthquake, a storm, a fire, a flood or a terrorist attack. In some cases, a system failure, such as a computer system failure or a power outage that affects the database storage, can also be regarded as a disaster event.

In exemplary embodiments, system 100 stores a database produced and/or used by one or more data sources 112 of a processor 102. The data source 112 may include an application server of an information technology system and/or any other system that produces or uses the database. In order to protect the database, the system 100 asynchronously replicates the database and stores it in two or more storage devices. In exemplary embodiments, system 100 includes a primary storage device 104 and a secondary storage device 106, which each store copies of the database. Storage devices 104 and 106 may include disks, magnetic tapes, computer memory devices, and/or devices based on any other suitable storage technology. In some embodiments, the storage devices include processors (not shown) that perform local data storage and retrieval-related functions. In exemplary embodiments, databases stored at the primary storage device 104 and the secondary storage device 106 utilize logging to track changes made to the databases. Database logging is typically used to recover from a failure and to synchronize databases stored at primary and secondary locations. Database logs typically include records of all changes to the database.

In exemplary embodiments, the primary and secondary storage devices 104 and 106 may be physically located at two separate sites. The sites are typically chosen to be sufficiently distant from one another so that a disaster event in one of the sites will be unlikely to affect the other. In exemplary embodiments, the primary storage device 104 may be collocated with the data source 112 at a local site, and the secondary storage device 106 may be located at a remote site. In exemplary embodiments, the primary storage device 104 includes a asynchronous replication application (e.g., IBM's zGlobal Mirror™ technology) 108, which performs mirroring, or replicating, of the database produced or used by data source 112 from the primary storage device 104 to the secondary storage device 106.

In exemplary embodiments, data source 112 can be used to send writes to the database log to one or more secure storage units 110 for temporary storage. In order to minimize transaction latency, the processor 102 and secure storage units 110 are typically collocated with the asynchronous replication application 108. In exemplary embodiments, the data source 112 of the processor 102 is configured to forward every database log write to the secure storage unit 110. The data source 112 of the processor 102 is also configured to forward every database log write and database write to the primary storage device 104. In exemplary embodiments, the data source 112 is configured to identify both database writes and database log writes. The data source 112 is configured to provide the database writes and database log writes to the primary storage device 104 and while also providing the log writes to the secure storage unit 110. Both log writes must complete successfully before the data source 112 is signaled that the log write has completed. The processor 102 aggregates the completion of the two write operations before signaling the data source 112 that the log write is complete. In the event of a disaster event which disrupts the normal operation of the asynchronous replication application 108, the database log writes that were previously sent to the secure storage units 110 are transmitted to the secondary storage device 106 at the remote, or secondary, site. Software at the secondary site constructs an archive log from the data and the standard database log recovery process is executed to make the database current in the recovery site.

In exemplary embodiments, the processor 102 is connected to one or more secure storage units 110 that may be deployed at different locations at or around the primary site. The secure storage units 110 are constructed in a durable manner, so as to enable them to withstand disaster events while protecting the stored data. After a disaster event hits the primary site, at least one of the secure storage units 110 can be used to ensure that the database at the secondary site is fully up-to-date and data consistent with the database at the primary site prior to the disaster event. The database log information stored in the secure storage units 110 is transmitted to the secondary site and used to update the database in the secondary storage device 106.

In exemplary embodiments, the secure storage units 110 are designed to store all database log writes which may have been occurred on the primary storage device 104 but have not yet been successfully mirrored to the secondary storage device 106. In exemplary embodiments, the secure storage units 110 may be designed to store database log writes that have occurred in a specified period of time to account for the network latency between the primary storage device 104 and the secondary storage device 106. In order to provide a high level of protection and reliability, it is required to avoid memory overflow in secure unit storage 110 before the asynchronous replication of that log data to the secondary storage device is complete, so that database log writes are not lost. Generally, a database log write can be safely deleted from the secure storage unit 110 when the corresponding write command has been successfully carried out by the secondary storage device 106. There are several alternative methods of indicating to processor 102 when it is permitted to delete a database log write from the secure storage unit 110, sometimes depending on the functionality of the asynchronous replication application.

In exemplary embodiments, one or more environmental sensors 122 can be installed at or near the primary storage device 104 and connected to processor 102. The environmental sensors 122 can be used for sensing environmental conditions, which may provide early detection, or prediction, of a developing disaster event. For example, environmental sensors 122 may include temperature sensors that sense a rising temperature at or near the primary storage device 104. Additionally or alternatively, environmental sensors 122 may include seismographic sensors that sense the vibrations associated with a developing earthquake. In addition, environmental sensors 122 may include any other suitable sensor type that enables early prediction of developing disaster conditions.

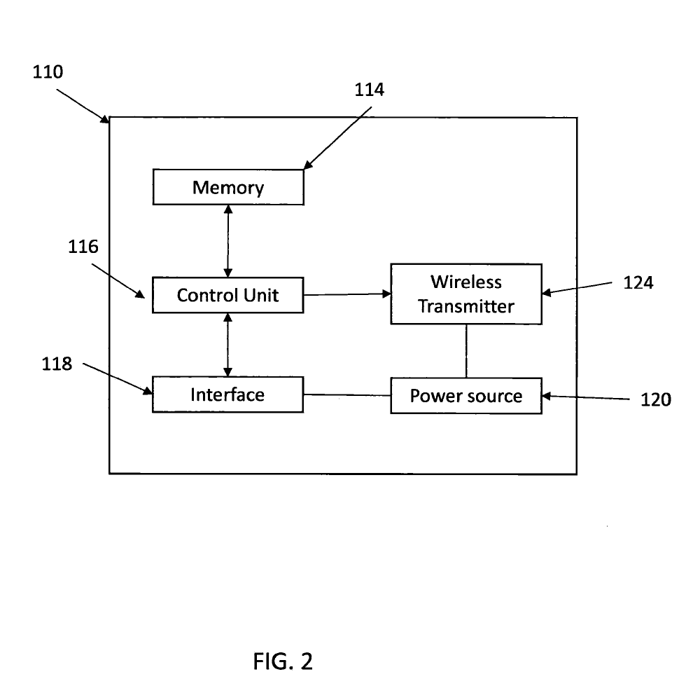

Turning now to FIG. 2, a block diagram of a secure storage unit 110 in accordance with an embodiment is shown. The secure storage unit 110 includes a memory 114, which holds database log writes, as described above. In exemplary embodiments, memory 114 may be a non-volatile memory device, an electrically erasable programmable read only memory (EEPROM) device, or any other suitable non-volatile or battery-backed memory device. In exemplary embodiments, secure storage unit 110 may include a control unit 116, which performs the various data storage and management functions of the secure storage unit 110. The secure storage unit 110 may include an interface circuit 118, which handles the physical interface between the secure storage unit 110 and asynchronous replication application 108. In exemplary embodiments, the control unit 116 of the secure storage unit 110 includes a detection mechanism that detects disaster events. For example, the detection mechanism may detect the absence of electrical power and/or communication with processor 102, conclude that a disaster even occurred. In exemplary embodiments, the detection mechanism may be configured to detect indications of a disaster event that the environmental sensors 122 may not be configured to detect.

In exemplary embodiments, secure storage unit 110 includes a wireless transmitter 124 coupled to a communication antenna. The transmitter 124 is typically powered by power source 120. The power source 120 may include a rechargeable battery, which is charged by electrical power provided via interface 118 during normal system operation. In exemplary embodiments, power source 120 may be used to power control unit 116 and/or memory 114. The transmitter 124 may be used for transmitting the database log writes stored in memory 114 to a wireless receiver, when the communication between secure storage unit 110 and processor 102 is broken due to a disaster event. As such, transmitter 124 and its antenna serve as alternative communication means for transmitting information from the secure storage unit 110. Using the wireless channel, data stored in the secure storage unit 110 can be retrieved and reconstructed within minutes. In exemplary embodiments, the transmitter 124 may be, for example, a cellular transmitter, a WiMax transmitter, or any other suitable data transmitter type. The wireless receiver is coupled to the secondary storage device 106.

In exemplary embodiments, the system 100 only stores a copy of all writes to a database log in the secure storage unit 110 for a set amount of time before deleting. The set amount of time can be a fixed time period, such as one, two, or five minutes or it can be a variable amount of time that is related to the network latency associated with mirroring the database log from the primary storage device 104 to the secondary storage device 106. After the time interval since a database log write was written elapses, the secure storage unit 110 may automatically delete the database log write or may mark the database log write for deletion when the memory 114 becomes full.

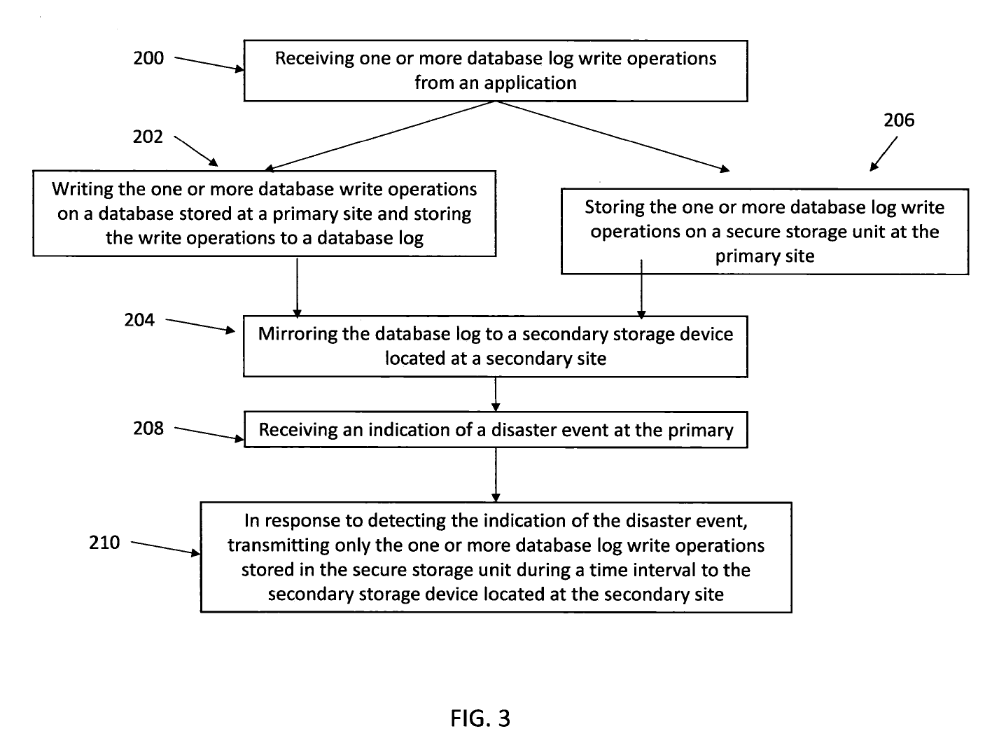

Referring now to FIG. 3, a flow diagram of a method for reducing data transfers while eliminating data loss during database replication in accordance with an exemplary embodiment is generally shown. As shown at block 200, the method includes receiving one or more database log write operations from an application. Next, the one or more database write operations are written to a database stored at a primary site and the write operations are stored in a database log at the primary site, as shown at block 202. As shown at block 206, the one or more database log write operations are stored on a secure storage unit at the primary site. The method also includes storing the one or more database log write operations on a secure storage unit at the primary site, as shown at block 206. The method further includes receiving an indication of a disaster event at the primary site, as shown at block 208. In exemplary embodiments, the indication of a disaster event may be received from one or more sensors at the primary site. As shown at block 210, the method includes transmitting only the one or more data base log operations stored to the secure storage unit during a time interval to the secondary storage device located at the secondary site, in response to detecting the indication of the disaster event. These log records are used as part of the standard database recovery processing that brings a down level consistent copy of the database up to currency.

In exemplary embodiments, the system 100 only stores database log writes to the secure storage unit 110. By only storing database log writes to the secure storage unit 110, rather than all updates to the database and the database logs, the system 100 reduces the amount of data that the secure storage unit 110 by approximately fifty percent. As a result of reducing in data stored in the secure storage unit 110, the system also reduces the amount of data that needs to be transmitted to the secondary storage device 106 in the event of a failure of, or disaster at, the primary storage device 104.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The flow diagrams depicted herein are just one example. There may be many variations to this diagram or the steps (or operations) described therein without departing from the spirit of the invention. For instance, the steps may be performed in a differing order or steps may be added, deleted or modified. All of these variations are considered a part of the claimed invention.

While the preferred embodiment to the invention had been described, it will be understood that those skilled in the art, both now and in the future, may make various improvements and enhancements which fall within the scope of the claims which follow. These claims should be construed to maintain the proper protection for the invention first described.

1-6. (canceled)

7. A computer program product for reducing data transfers while eliminating data loss during database replication, the computer program product comprising:
a tangible storage medium readable by a processing circuit and storing instructions for execution by the processing circuit for performing a method comprising:
receiving one or more database log write operations caused by an application making updates to a database;
writing the one or more database log write operations on a database log stored at a primary site;
asynchronously mirroring the database log to a secondary storage device located at a secondary site;
synchronously storing the one or more database log write operations on a secure storage unit at the primary site;
receiving an indication of a disaster event at the primary site; and
in response to the indication of the disaster event, transmitting only the one or more database log write operations stored on the secure storage unit during a time interval to the secondary storage device.

8. The computer program product of claim 7, wherein the time interval is a two minute time period immediately preceding the indication of the disaster event.

9. The computer program product of claim 7, wherein transmitting only the one or more data base log write operations stored on the secure storage unit during the time interval to the secondary storage device located at the secondary site is done wirelessly.

10. The computer program product of claim 7, further comprising deleting the one or more data base log write operations stored on the secure storage unit after the time interval.

11. The computer program product of claim 7, wherein the time interval is at least twice a network latency associated with mirroring the first database log to the secondary storage device located at the secondary site.

12. The computer program product of claim 7, wherein storing the one or more database log write operations on the secure storage unit at the primary site includes storing the one or more database log write operations on a non-volatile memory of the secure storage unit.

13. A system for reducing data transfers while eliminating data loss during asynchronous database replication, the system comprising:
a primary storage device for storing a database log reflecting updates to a database;
a secondary storage device in communication with the primary storage device for storing an asynchronous mirrored copy of the database and the database log; and
a secure storage unit in communication with the primary storage device, the system configured to perform a method comprising:
receiving one or more database log write operations caused by an application making updates to the database;
writing the one or more database log write operations on the database log;
asynchronously mirroring the database log to the secondary storage device;
synchronously storing the one or more database log write operations on the secure storage unit;
receiving an indication of a disaster event at the primary storage device site; and
in response to the indication of the disaster event, transmitting only the one or more database log write operations stored on the secure storage unit during a time interval to the secondary storage device.

14. The system of claim 13, wherein the time interval is a two minute time period immediately preceding the indication of the disaster event.

15. The system of claim 13, wherein transmitting only the one or more data base log write operations stored on the secure storage unit during the time interval to the secondary storage device located at the secondary site is done wirelessly.

16. The system of claim 13, wherein the method further comprises deleting the one or more data base log write operations stored on the secure storage unit after the time interval.

17. The system of claim 13, wherein the time interval is at least twice a network latency associated with mirroring the first database log to the secondary storage device located at the secondary site.

18. The system of claim 13, wherein storing the one or more database log write operations on the secure storage unit at the primary site includes storing the one or more database log write operations on a non-volatile memory of the secure storage unit.
